(19) United States
(12) Patent Application Publication
(10) Pub. No.: US 2026/0039727 A1
(43) Pub. Date: Feb. 5, 2026

(54) Network Device with Context Handoff Interface

(71) Applicant: Mellanox Technologies, Ltd., Yokneam (IL)

(72) Inventors: Tsahi Daniel, Tel Aviv (IL); Idan Burstein, Carmiel (IL); Avi Urman, Yokneam (IL); Santhanakrishnan Geeyarpuram, Cupertino, CA (US)

(21) Appl. No.: 18/793,817

(22) Filed: Aug. 4, 2024

(51) Int. Cl. H04L 69/22; H04L 49/00

(52) U.S. Cl. CPC H04L 69/22; H04L 49/3063; H04L 2212/00

(57) ABSTRACT

A network device includes a packet processing pipeline and handoff circuitry. The packet processing pipeline is to apply to a packet a sequence of commands, one of the commands being a handoff command that diverts processing of the packet to an external device. The handoff circuitry is to generate, in response to the handoff command, an output context indicative of a current processing state of the packet, to send the output context to the external device, to receive from the external device an input context that (i) reflects the processing applied to the packet by the external device and (ii) specifies subsequent processing of the packet by the packet processing pipeline, and to forward the input context to the packet processing pipeline.

### TECHNICAL FIELD

The present description relates generally to network devices, and particularly to joint packet processing by a network device and an external device such as a Field-Programmable Gate Array (FPGA).

### BACKGROUND

Network devices, such as network adapters and Data Processing Units (DPUs-sometimes referred to as “smart NICs”), typically comprise pipelines that perform various packet processing operations.

### SUMMARY

An embodiment that is described herein provides a network device including a packet processing pipeline and handoff circuitry. The packet processing pipeline is to apply to a packet a sequence of commands, one of the commands being a handoff command that diverts processing of the packet to an external device. The handoff circuitry is to generate, in response to the handoff command, an output context indicative of a current processing state of the packet, to send the output context to the external device, to receive from the external device an input context that (i) reflects the processing applied to the packet by the external device and (ii) specifies subsequent processing of the packet by the packet processing pipeline, and to forward the input context to the packet processing pipeline.

In some embodiments, the output context includes (i) a header of the packet and (ii) metadata associated with the packet. In a disclosed embodiment, the input context includes a modified header of the packet, as modified by the external device. In an example embodiment, the input context specifies a command to be applied next to the packet by the packet processing pipeline. In an embodiment, the packet is encrypted prior to processing by the packet processing pipeline, and the packet processing pipeline is to divert processing of the packet to the external device at least first and second times, the first time for decrypting the packet and the second time for processing the decrypted packet.

In some embodiments, the packet processing pipeline includes multiple lookup engines to apply the commands to multiple packets in parallel, a given lookup engine to divert processing of a given packet to the external device in response to a lookup result being the handoff command. In an example embodiment, the given lookup engine is to retain state information of the given packet, to wait until the given packet has been processed by the external device, and then to resume processing of the given packet using the retained state information. In an alternative embodiment, any of the lookup engines is to receive the input context of the given packet after processing by the external device, to further receive state information of the given packet, and to resume processing of the given packet using the received state information.

In some embodiments, the packet processing pipeline and the handoff circuitry are implemented in a first chip, the external device is implemented in a second chip, and the handoff circuitry is to send the output context and receive the input context over a communication bus connecting the first and second chips.

There is additionally provided, in accordance with an embodiment that is described herein, a method for packet processing. The method includes applying, in a packet processing pipeline, a sequence of commands to a packet, one of the commands being a handoff command that diverts processing of the packet to an external device. An output context, indicative of a current processing state of the packet, is generated in response to the handoff command. The output context is sent to the external device. An input context, which (i) reflects the processing applied to the packet by the external device and (ii) specifies subsequent processing of the packet by the packet processing pipeline, is received from the external device. The input context is forwarded to the packet processing pipeline.

The present description will be more fully understood from the following detailed description of the embodiments thereof, taken together with the drawings in which:

### BRIEF DESCRIPTION OF THE DRAWINGS

FIG. 1 is block diagram that schematically illustrates a system comprising a network device operating in conjunction with an external device, in accordance with an embodiment that is described herein;

FIG. 2 is a flow chart that schematically illustrates a method for packet processing by the network device of FIG. 1, in accordance with an embodiment that is described herein;

FIG. 3 is a table listing an example set of packet-processing commands, in accordance with an embodiment that is described herein;

FIG. 4 is a diagram that schematically illustrates receive (Rx) packet processing in the system of FIG. 1, in accordance with an embodiment that is described herein;

FIG. 5 is a diagram that schematically illustrates transmit (Tx) packet processing in the system of FIG. 1, in accordance with an embodiment that is described herein; and

FIGS. 6 and 7 are block diagrams that schematically illustrate parallelized pipeline processing and context handoff schemes, in accordance with embodiments that are described herein.

### DETAILED DESCRIPTION OF EMBODIMENTS

### Overview

A network device, e.g., a network adapter or DPU, typically performs sequences of transmit (Tx) and/or receive (Rx) packet processing operations. An Rx sequence may comprise, for example, receiving a packet from a network, parsing the packet header, decapsulating selected header fields, decrypting the packet payload and sending the packet to a selected receive queue. A Tx sequence may comprise, for example, receiving data for transmission from a host, encrypting the data, composing a packet that comprises the data and a header, encapsulating the packet and forwarding the packet to the network.

One way of implementing a network device is using one or more packet processing pipelines, e.g., an Rx pipeline and a Tx pipeline. In an example implementation, each packet being processed by the pipeline has a respective state that the pipeline saves in memory and updates during processing. The pipeline operates as a “match-action” machine that executes a sequence of packet processing commands, each command specifying a certain packet processing operation.

The pipeline obtains the next command to be applied to a given packet by matching one or more attributes of the packet (e.g., header fields) to a set of rules. A successful match specifies an “action”—a command to be applied to the packet. The pipeline executes the command, updates the state of the packet as a result of the command, and proceeds to the next processing cycle. The process may continue, for example, until the packet is transmitted to the network (on Tx) or until the packet data is delivered to the host (on Rx).

In some practical cases, it is desirable to perform at least some of the packet processing commands in an external device, outside the pipeline. For example, a user of the network device may wish to keep some or all of the “match-action” logic confidential. As another example, a user may wish to use the network device for emulating other devices, e.g., an NVMe or other storage device, but perform these functions outside the pipeline. In another valuable use-case, a user wishes to use a native Remote Direct Memory Access (RDMA) network adapter for Virtual Machines (VMs) running on a host, but prefers to use its own Software-Defined Network (SDN) layer which is implemented on an external device, such as an FPGA.

Embodiments that are described herein provide improved network devices that are capable of handing-off some or all of the packet processing to an external device. The external device may comprise, for example, an FPGA, a processor, or any other suitable device.

In disclosed embodiments, the pipeline of a network device supports a set of packet processing commands. Among the various commands, the command set includes a “handoff” command that diverts processing of a packet to an external device. The network device further comprises handoff circuitry that manages handoff between the pipeline and the external device.

Typically, in response to a handoff command, the handoff circuitry generates an “output context” indicative of the current processing state of the packet, and sends the output context to the external device. The output context typically comprises the packet header and relevant metadata. The external device processes the packet using any suitable logic implemented therein.

To return control to the pipeline, the external device sends the pipeline an “input context”. The input context (i) reflects the processing applied to the packet by the external device, and (ii) specifies subsequent processing of the packet by the packet processing pipeline (e.g., specifies the next command in the set to be applied to the packet). The handoff circuitry instructs the pipeline to resume processing of the packet in accordance with the input context received from the external device.

The disclosed handoff mechanism enables the external device to fully orchestrate the packet processing flow as needed, while possibly overriding some or all of the pipeline functionality. Functions carried out by the external device may comprise, for example, packet steering, packet lookup, packet actions, network cryptography operations, transport operations, etc. When using the disclosed handoff mechanism, the external device may carry out packet processing logic that is not known or accessible to the pipeline.

In various implementations, the overall packet processing functionality can be partitioned between the pipeline and the external device in any desired manner. Example use-cases include the following:
Remote Direct Memory Access (RDMA) transport implemented in network device or in external device.
Emulation of storage devices (e.g., virtio_net or NVMe) implemented in network device or in external device.
NIC functions implemented in network device, while customer Software-Defined Network (SDN) layer implemented in external device. Storage device emulation implemented in network device.
A user serves native RDMA VMs, which run on a host, by an RDMA network adapter. An SDN layer, however, is implemented in an external device, e.g., FPGA.

Examples of Rx and Tx flows, which utilize the disclosed handoff mechanism, are demonstrated herein. Two alternative parallelized configurations of the pipeline and the handoff circuitry are also described.

### System Description

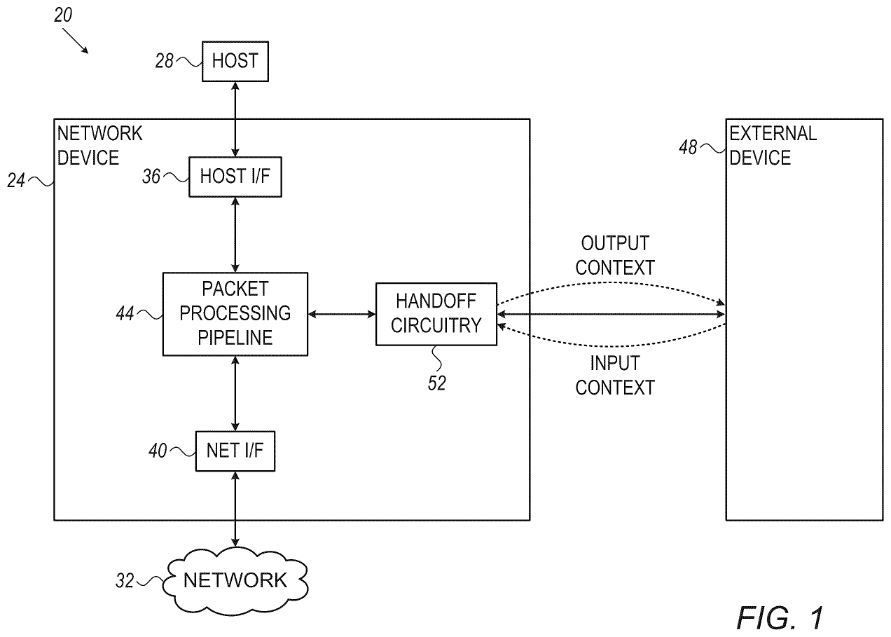

FIG. 1 is a block diagram that schematically illustrates a system 20 comprising a network device 24 operating in conjunction with an external device 48, in accordance with an embodiment that is described herein.

Network device 24 may comprise, for example, a network adapter such as Ethernet Network Interface Controller (NIC) or InfiniBand™ (IB) Host Channel Adapter (HCA), a DPU, or any other suitable type of network device. External device 48 may comprise, for example, an FPGA, a processor, or any other suitable type of device.

Network device 24 connects a host 28 to a network 32. Host 28 may comprise, for example, a Central Processing Unit (CPU), a Graphics Processing Unit (GPU) or any other suitable processor in a server or other computer. Network 32 may comprise, for example, an Ethernet or IB network. In serving host 28, network device 24 sends packets to network 32 and receives packets from network 32. System 20 may be used in any suitable environment, e.g., in a data center.

In the present example, network device 24 comprises a host interface for communicating with host 28, a network interface 40 for communicating with network 32, a packet processing pipeline 44, and handoff circuitry 52. Packet processing pipeline 44 typically comprises an Rx pipeline that processes inbound packets received from network 32, and a Tx pipeline that processes outbound packets for transmission to network 32.

Handoff circuitry 52 hands-off processing of packets from pipeline 44 to external device 48, and returns processing from external device 48 to pipeline 44, as will be described in detail below. To hand-off processing of a given packet to external device 48, handoff circuitry sends the external device an output context of the packet. To return processing of the packet from the external device to pipeline 44, handoff circuitry receives an input context of the packet from the external device. Typically, handoff circuitry 52 handles two bidirectional handoff interfaces in parallel-One for inbound packets (packets from network 32 to host 28), and another for outbound packets (packets from host 28 to network 32).

Network device 24 and external device 48 may be connected using any suitable communication bus. The communication bus may be standard or proprietary. In one example, the network device and the external device communicate using Advanced Extensible Interface (AXI) over a Universal Chiplet Interconnect express™ (UCIe) chip-to-chip bus. Alternatively, any other suitable interface can be used.

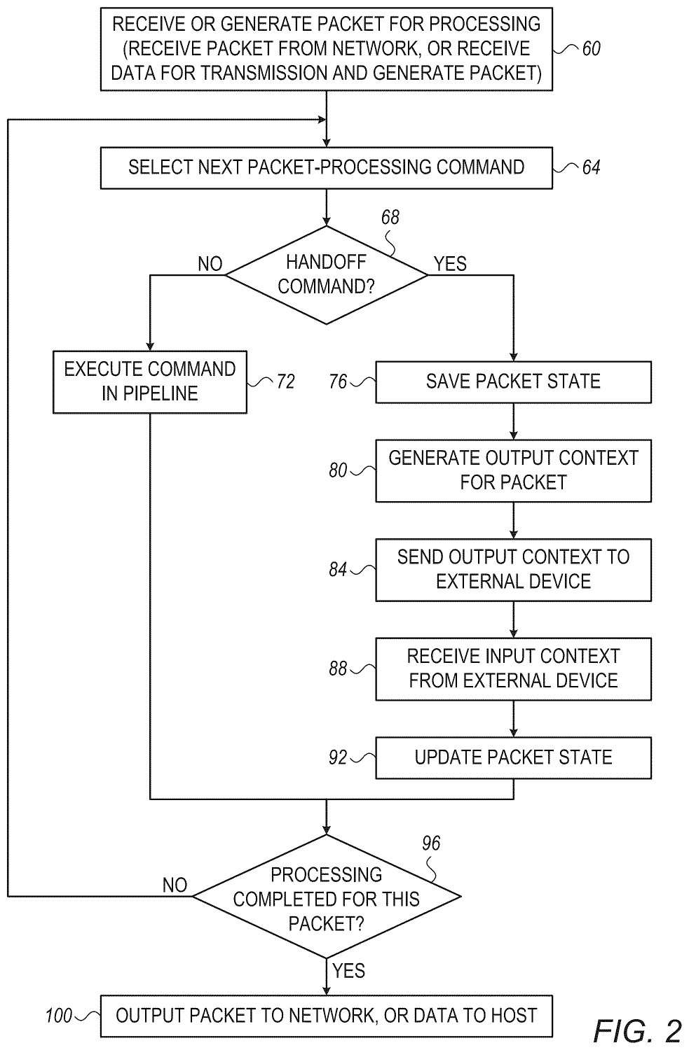

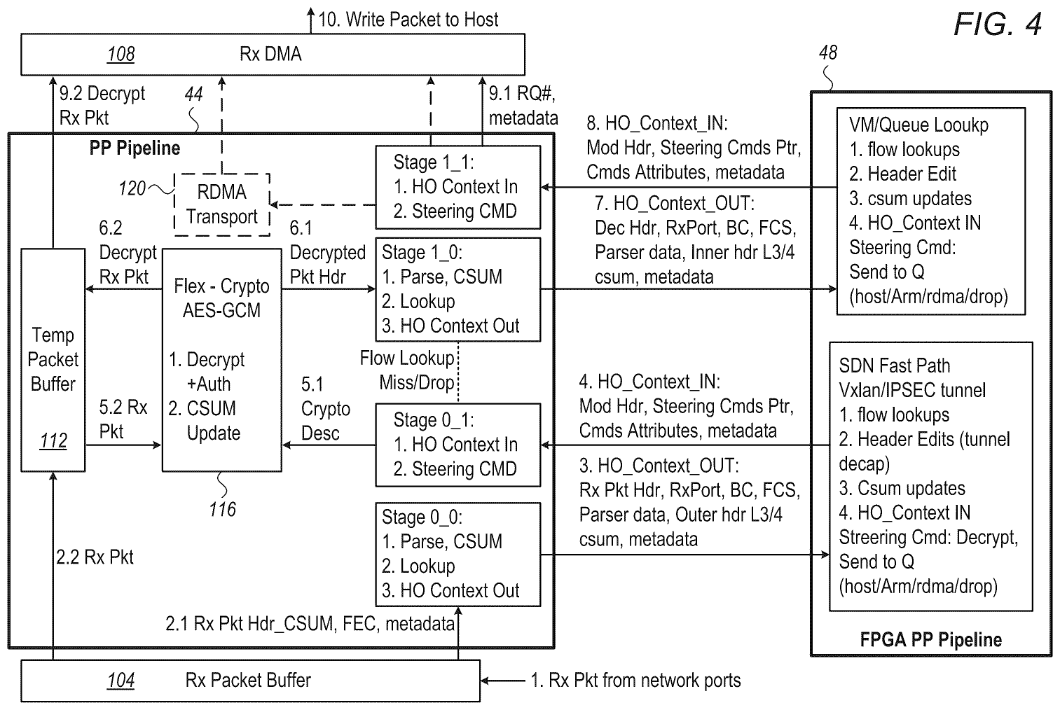

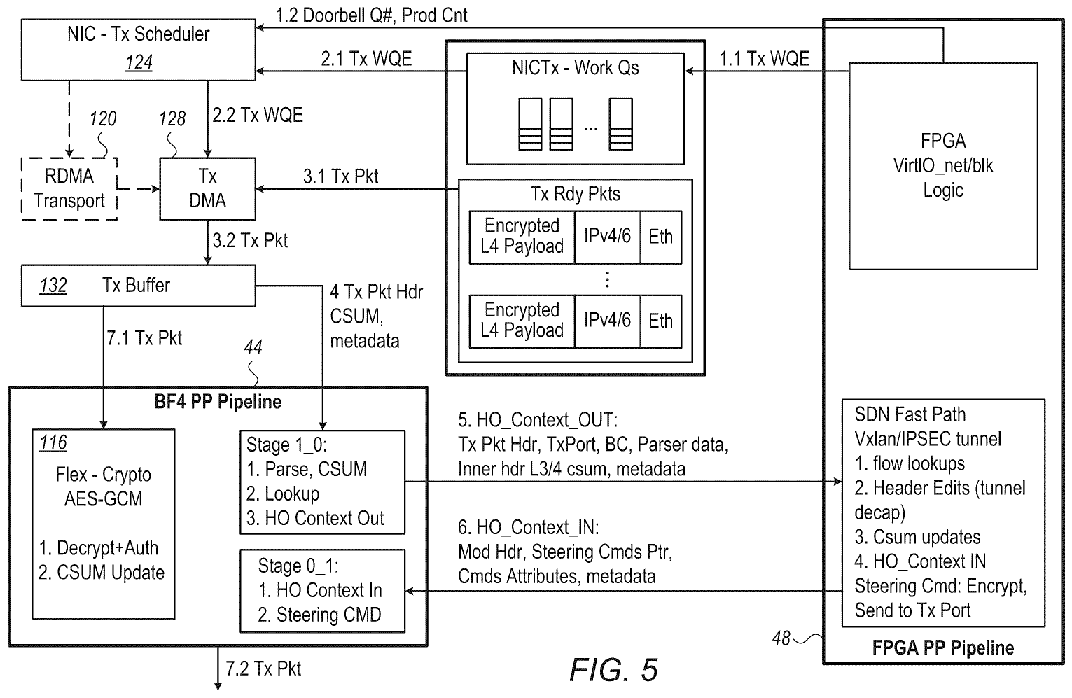

FIG. 2 is a flow chart that schematically illustrates a method for packet processing by network device 24 in conjunction with external device 48, in accordance with an embodiment that is described herein. The flow below is a general flow that applies to both Rx processing and Tx processing. Detailed Rx and Tx flows are given below in FIGS. 4 and 5, respectively. The description below refers to a single packet, for simplicity of explanation. As its name suggests, pipeline 44 typically processes multiple packets concurrently, in a pipelined manner.

The method of FIG. 2 begins with network device 24 receiving or generating a packet for processing, at an input stage 60. In Rx processing, stage 60 includes receiving an inbound packet from network 32 by network interface 40. The inbound packet is to be processed by pipeline 44 and external device 48, and then forwarded to host 28 via host interface 36. In Tx processing, stage 60 includes receiving data for transmission from host 28 via host interface 36, and generating an outbound packet that comprises the data. The outbound packet is to be processed by pipeline 44 and external device 48, and then sent to network 32 via network interface 40. In both cases, network device 24 creates an initial state for the packet and saves the state in memory.

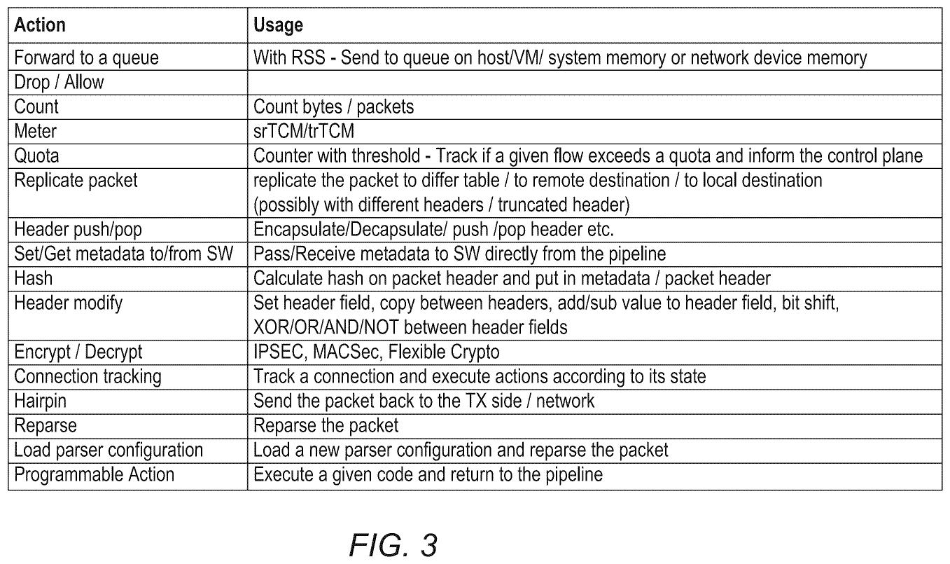

At a command selection stage 64, pipeline 44 selects the next packet processing command to be applied to the packet. Pipeline 44 selects the next command by matching one or more packet attributes to a set of rules. The packet attributes may comprise any suitable attributes taken from the packet state, e.g., values of header fields, relevant metadata and the like. In various embodiments, network device 24 may support any suitable set of packet processing commands. An example command set is depicted in FIG. 3 below.

At a handoff checking stage 68, pipeline 44 checks whether the next command is a handoff command. If not, pipeline 44 executes the command, at an execution stage 72. If the command is a handoff command, pipeline 44 halts processing of the packet, and saves the up-to-date packet state in memory, at a state saving stage 76.

At an output context generation stage 80, handoff circuitry 52 generates an output context for the packet. The output context typically comprises the packet header plus relevant metadata. The metadata may comprise, for example, the Rx/Tx port of the packet, the size of the packet (e.g., byte count), Frame Check Sequence (FCS) error, Layer 3 checksum and/or Layer 4 checksum, parser data, the state of the packet as saved by the pipeline, and/or any other suitable metadata. At an output context sending stage 84, handoff circuitry 52 sends the output context to external device 48.

In response to the output context, external device 48 processes the packet and generates an input context. The input context, too, comprises the packet header plus relevant metadata. The information in the input context reflects the processing applied to the packet by the external device. The processing may affect the packet header (the external device may edit one or more of the packet header fields) and/or the metadata. Among other information, the metadata in the input context specifies the next packet processing command to be applied to the packet by pipeline 44. At an input context reception stage 88, handoff circuitry 52 receives the input context from external device 48.

At a state updating stage 92, handoff circuitry 52 updates the packet state saved in memory. At this point, pipeline 44 is ready to regain control of subsequent processing of the packet. At a completion checking stage 96, pipeline 44 checks whether processing of the packet is completed. For example, pipeline 44 may check whether the latest command being executed was a “send to queue” command. This command instructs the pipeline to post the packet on a Rx queue for forwarding to host 28 (in Rx processing), or on a Tx queue for forwarding to network 32 (in Tx processing).

If processing of the packet is not yet completed, the method loops back to stage 64 above, in which pipeline 44 selects the next packet processing command. If processing of the packet is completed, pipeline 44 outputs the packet data to host 28 (in Rx processing) or outputs the packet to network 32 (in Tx processing), at an output stage 100.

The method of FIG. 2 is an example method that is depicted purely for the sake of conceptual clarity. In alternative embodiments, any other suitable method can be used. When handing-off multiple packets in parallel, the external device may return the input context out-of-order (i.e., in an order that is different from the order of the output contexts). Typically, however, the external device should preserve the order of input contexts of packets belonging to the same packet flow.

FIG. 3 is a table listing an example set of packet-processing commands supported by pipeline 44, in accordance with an embodiment that is described herein. Each row of the table corresponds to a respective packet processing command. The “Action” column gives the command name. The “Usage” column gives a description of the command. External device 48 may support some or all of the commands in the set. When returning an input context, external device 48 may specify any of the commands as the next command to be applied by pipeline 44. In alternative embodiments, any other suitable command set can be used.

### Stateless Offload

In some embodiments, network device 24 (in conjunction with external device 48) performs one or more offloading tasks that require the entire packet payload. Examples of such tasks include:
Validation of packet FCS on Rx (ingress).
Generation of packet FCS on Tx (egress).
Validation of L3 and/or L4 checksums on Rx.
Generation of L3 and/or L4 checksums on Tx.
Validation of ROCEv2 iCRC on Rx.
Generation of ROCEv2 iCRC on Tx

The interface between network device 24 and external device 48 may support these tasks. For example, in Rx processing, network device 24 should forward the validation state of the packet to external device 48 as part of the output context.

### Example Handoff Context Formats

In various embodiments, system 20 may use output contexts and input contexts having any suitable sizes and formats. In some embodiments, the size and format of the output context are the same as those of the input context. In an example embodiment, the handoff context (output or input) comprises a total of 384 bytes, of which 256 bytes contain the packet header and 128 bytes contain metadata. In another embodiment, the handoff context comprises a total of 256 bytes, of which 192 bytes contain the packet header and 64 bytes contain metadata. In yet another embodiment, the handoff context comprises a total of 192bytes, of which 128 bytes contain the packet header and 64 bytes contain metadata. Further alternatively, any other suitable sizes can be used. In some embodiments the format and/or size of the output context may differ from those of the input context.

In an example embodiment, the output context comprises the following:

Current packet header. On Rx (ingress, inbound packets), the current packet header may be encrypted or decrypted (i.e., before or after decryption), depending on the processing stage at which the handoff is performed. On Tx (egress, outbound packets), the current packet header is a user generated or RDMA-over-Converged Ethernet (ROCE) header, before SDN tunnel encapsulation and network encryption.

Metadata (typically based on state registers of pipeline 44) including:
Basic Packet information and Tags (e.g., Rx/Tx Port, Headers sizes and offsets, Tags for retrieving packet context and payload when external device replies).
Stateless offloads results (e.g., L3 checksum of all IPv4 headers in clear text, L4 Checksum for all L4 headers in clear text, ROCEv2 iCRC, FCS on Rx).
Packet parsing information (e.g., Layer Formats, Layer offsets).
Packet processing state in pipeline-Any state accumulated doing packet processing (e.g., lookup results, etc.).

In an example embodiment, the input context comprises the following:

Updated packet header. Since the external device may modify the packet header, the packet header returned in the input context (for merging with the packet payload) may differ than the packet header provided in the corresponding output context. The external device may modify any suitable header field, e.g., perform tunnel decapsulation and encapsulation (by stripping or adding header fields), decrementing the packet Time-To-Live (TTL), NAT, etc. Typically, the external device should ensure that the header L3 and L4 checksums are updated to reflect valid checksums.

Metadata, including:
Basic Packet information and Tags (Rx/Tx Port, Header sizes and offsets, Tags taken from the corresponding output context).
Pointer to Command set (e.g., to the table of FIG. 3) indicating the next command to be executed by pipeline 44 upon resuming processing.
Command Arguments-Arguments for the next command (e.g., queue number, Security Association (SA) pointer, cryptography parameters, etc.) The formats above are given purely by way of example. In alternative embodiments, any other suitable formats can be used for the output and/or input context.

### Detailed RX and TX Flows

FIG. 4 is a diagram that schematically illustrates the Rx packet processing flow in system 20 of FIG. 1, in accordance with an embodiment that is described herein. In this example, packets arriving from network 32 are buffered in an Rx packet buffer 104. Packets that completed processing are sent to the host by a Direct Memory Access (DMA) engine 108. Network device 24 comprises a temporary packet buffer 112 for buffering the packets being processed, and a cryptography engine 116 for performing cryptographic operations such as decryption, authentication and checksum updating. In an embodiment, the cryptographic operations are in accordance with AES-GCM.

The example Rx flow of FIG. 4 comprises the following stages:
1. A packet is received from network 32 and is stored in Rx packet buffer 104. In an embodiment, the buffer size is 4 MB, and serves as a Priority Flow Control (PFC) buffer. At this stage, the packet is classified and moved to temporary buffer 112. The packet checksum is calculated.
2. The packet header is forwarded to pipeline 44. Pipeline 44 parses the packet, validates the packet checksum and performs a lookup for the next packet processing command to be executed on the packet. If the command is a handoff command, handoff circuitry 52 generates an output context for the packet, and forwards the output context to external device 48. At this stage, the packet is network encrypted (IPSEC) and only the most outer header is in clear text.
3. External device 48 performs SDN Fast Path lookups to retrieve the packet Security Association (SA). The external device receives the output context for the packet from circuitry 52. The external device uses the packet header and the parsing information given in the output context, to generate lookup keys. The external device fetches a Network Crypto Security Association Entry (SA). The external device edits the packet header (removes SDN encapsulation) and updates the L3 and L4 checksums. The external device then generates an input context for the packet. The input context comprises the updated header, SA pointer, and flex crypto arguments. If the lookup resulted in a miss, the external device sets the next command in the input context to be a forwarding command, which forwards the packet to a receive queue of the SDN control plane (running in network device 24).
4. Pipeline 44 executes next commands—AES-GCM decryption and authentication. Pipeline 44 receives the input context from external device 48, and performs the next commands. The packet may be forwarded to a target receive queue (flow miss/drop), or continue processing in pipeline 44 and trigger AES-GCM decryption and authentication in engine 116. Pipeline 44 then uses the SA pointer given in the input context to read a Data Decryption Key (DEK). The DEK is decrypted by a Key Encryption Key (KEK).
5. Flex Crypto AES-GCM Decryption and Authentication. Pipeline 44 triggers AES-GCM engine 116 to decrypt and authenticate the packet. Different CSPs may support a variety of Encapsulating Security Payload (ESP) formats. Engine 116 supports various formats, e.g., IPSEC, UDP SEC and PSP. The packet is decrypted and authenticated by engine 116. Engine 116 writes the decrypted packet to temporary buffer 112. The checksum of the decrypted packet is calculated, and the decrypted header is forwarded to pipeline 44.
6. Decrypted header is forwarded to pipeline. Pipeline 44 parses the packet, validates the checksum and performs a lookup. If the command returned by the lookup is a handoff command, handoff circuitry 52 generates an output context for the packet, and forwards the output context to external device 48. Note that in this flow, this is now the second time the same packet is handed-off to the external device. In the second hand-off, however, the packet header is a decrypted header, with user data in plaintext.
7. External device performs VM/Queue lookup. External device 48 receives the packet's output context from pipeline 44. The external device uses the packet header and parsing information, given in the output context, to generate lookup keys. The external device edits the packet header (e.g., decrements TTL, NAT) and updates L3 and L4 checksums. The external device generates an input context, which comprises the updated packet header, a pointer to the next command, and command attributes for the next command. If the lookup resulted in a miss, the external device sets the next command to be a forwarding command that forwards the packet to a receive queue of the SDN control plane (running in network device 24).
8. Pipeline 44 executes next commands—AES-GCM decryption and authentication. Pipeline 44 receives the input context from external device 48 and performs the next commands. The packet is forwarded to a target receive queue.
9. Rx DMA engine 108 writes packet to memory (host memory or a memory of network device 24).
10. Packet is written to Memory.

FIG. 5 is a diagram that schematically illustrates Tx packet processing in system 20 of FIG. 1, in accordance with an embodiment that is described herein. The example Rx flow of FIG. 4 comprises the following stages:
1. FPGA queues a packet for transmission. The process begins when a packet is ready for transmission in a memory of network device 24 or in the host memory. A packet ready for transmission has already been XTS encrypted (for block storage) or GCM encrypted (TLS) and includes a tenant header or ROCEv2 header. External device 48 adds CSP SDN header and network Crypto ESP to the packet. The external device prepares a Tx Work-Queue Element (WQE) and writes the WQE to the memory of network device 24. The external device then asserts a doorbell to the network device, indicating that the Tx WOE has been written.
2. Packet is scheduled for transmission. The packet is scheduled for transmission by a Tx scheduler 124 in network device 24. The Tx WOE is read from memory and forwarded to a Tx DMA engine 128.
3. Packet read from memory to Tx Buffer. DMA engine 128 reads packet from memory into a 2 MB Tx Buffer 132. The packet is held in Tx buffer 132 until it is to be transmitted.
4. Tx Packet forwarded to pipeline. Pipeline 44 parses the packet, updates the checksum and performs a lookup. If the lookup result is a handoff command, handoff circuitry 52 generates an output context for the packet and forwards the output context to external device 48.
5. External device performs SDN Fast Path lookups to retrieve SA. External device 48 receives the output context from handoff circuitry 52. The external device uses the packet header and parsing information, given in the output context, to generate lookup keys. The external device fetches Network Crypto Security Association Entry (SA). The external device edits the packet header (adds SDN encapsulation) and updates L3 and L4 checksums. The external device generates an input context, which comprises the updated packet header, SA pointer, and flex crypto arguments. If the lookup performed by the external device resulted in a miss, the external device sets the next command in the input context to be a forwarding command, which forwards the packet to a receive queue of the SDN control plane.
6. Pipeline executes next commands—AES-GCM encryption and authentication tag update. Pipeline 44 receives the input context from external device 48, and performs the next commands. The packet may be forwarded to a target receive queue (flow miss/drop) or continue processing in the pipeline and trigger AES-GCM Encryption and authentication in engine 116. The pipeline uses the SA pointer in the input context to read the DEK. The DEK is decrypted by a KEK.
7. Flex Crypto AES-GCM Encryption and Authentication. Pipeline 44 triggers cryptography engine 116 to encrypt and authenticate the packet. As noted above, engine 116 supports various ESP formats, e.g., IPSEC, UDP SEC and PSP. The packet is encrypted and authenticated by engine 116. The encrypted packet checksums are calculated, and the packet headers are updated. The packet is transmitted.

The Rx and Tx flows of FIGS. 4 and 5 are example flows that are depicted purely for the sake of conceptual clarity. In alternative embodiments, any other suitable flows can be used.

### Parallelized Pipeline Processing and Context Handoff Using Multiple Lookup Engines

In some embodiments, packet processing pipeline 44 of network device 24 comprises multiple lookup engines that operate in parallel, and a scheduler that distributes packets for processing by the lookup engines. Each lookup engine receives a packet for processing, performs a lookup to determine the next packet processing command to be applied to the packet, and then invokes the appropriate circuitry in pipeline 44 to execute the command. In this manner, pipeline 44 is capable of processing multiple packets and executing multiple packet processing commands concurrently. In some embodiments, each lookup engine is also capable of handing-off processing of packets to external device 48 using the disclosed techniques.

In some embodiments, each packet to be processed by the lookup engines (a received packet or a packet to be transmitted) is allocated a respective “slice” of pipeline. The term “slice” in this context means an allocation of processing resources that enable processing of the packet by pipeline 44.

In certain embodiments, when a lookup engine hands-off processing of a packet to external device 48, the lookup engine waits until the external device returns the processing to pipeline 44, and then resumes processing of the packet. In other words, a given packet is processed by the same lookup engine before and after the hand-off (i.e., in this implementation the lookup engines “do not release the slice of the packet” throughout the hand-off process). In these embodiments, the lookup engine retains the state of the packet until resuming the processing.

In alternative embodiments, a lookup engine releases the slice of a packet when handing-off processing of the packet to external device 48. In these embodiments, any of the lookup engines can resume processing of any packet that is returned from external device 48 to pipeline 44. In these embodiments, when resuming processing of a packet after hand-off, the state of the packet is provided to the lookup engine.

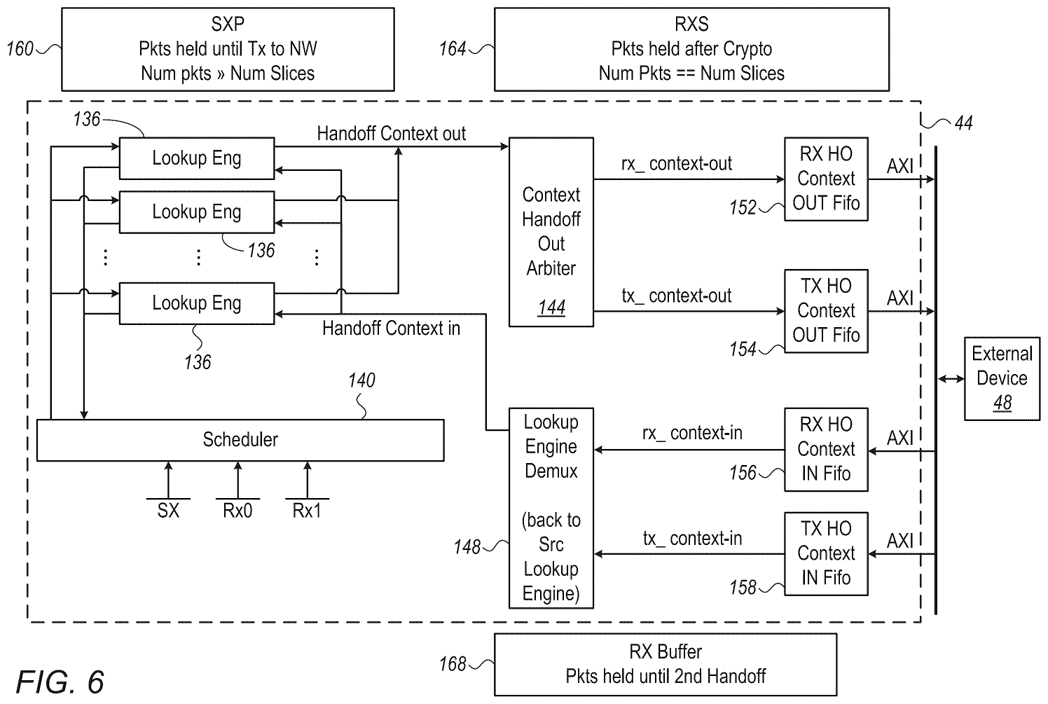

FIG. 6 is a block diagram schematically illustrates a parallelized pipeline processing and context handoff scheme, in accordance with an embodiment that is described herein. In this example, the lookup engines do not release the slice of a packet when handing-off processing to external device 48, i.e., a packet is processed by the same lookup engine before and after hand-off).

In this embodiment, pipeline 44 comprises multiple lookup engines 136. Any suitable number of lookup engines can be used, e.g., between 8-12. A scheduler 140 receives Rx and/or Tx packets for processing and distributes the packets to lookup engines 136. Each lookup engine 136 performs a lookup to select the next packet processing command to be applied to the packet. As described at length above, if the lookup result is a handoff command, the lookup engine diverts processing of the packet to external device 48.

To hand-off processing of a packet, lookup engine 136 generates an output context. (For the sake of clarity, the functionality of hand-off circuitry 52, e.g., generation of output contexts, is shown in FIG. 6 as embedded in lookup engines 136. In various embodiments, both implementations are possible.)

Pipeline 44 further comprises a handoff arbiter 144, an Rx output context First-In-First-Out queue (FIFO) 152 and a Tx output context FIFO 154. Arbiter 144 receives output contexts from the various lookup engines, sends the output contexts of Rx packets to FIFO 152, and sends the output contexts of Tx packets to FIFO 154. FIFOs 152 and 154 queue the output contexts and sends them to external device 48.

As described above, external device 48 returns processing of a packet to pipeline 44 by sending an input context. Pipeline 44 of FIG. 6 comprises an Rx input context FIFO 156 and a Tx input context FIFO 158. FIFO 156 receives and queues the input contexts of Rx packets that are received from external device 48. FIFO 158 receives and queues the input contexts of Tx packets received from the external device. A demultiplexer 148 receives the various input contexts from FIFOs 156 and 158, and sends each input context to the lookup engine 136 that handled the packet before the handoff. The lookup engine 136 resumes processing of the packet using the retained slice.

Also seen in FIG. 6 are three packet buffers: A Tx (SXP) buffer that buffers Tx packets until they are transmitted to network 32, an Rx buffer 168 that buffers Rx packets until the second handoff of the Rx flow, and an RXS buffer 164 that buffers Rx packets after decryption until they are sent to the host.

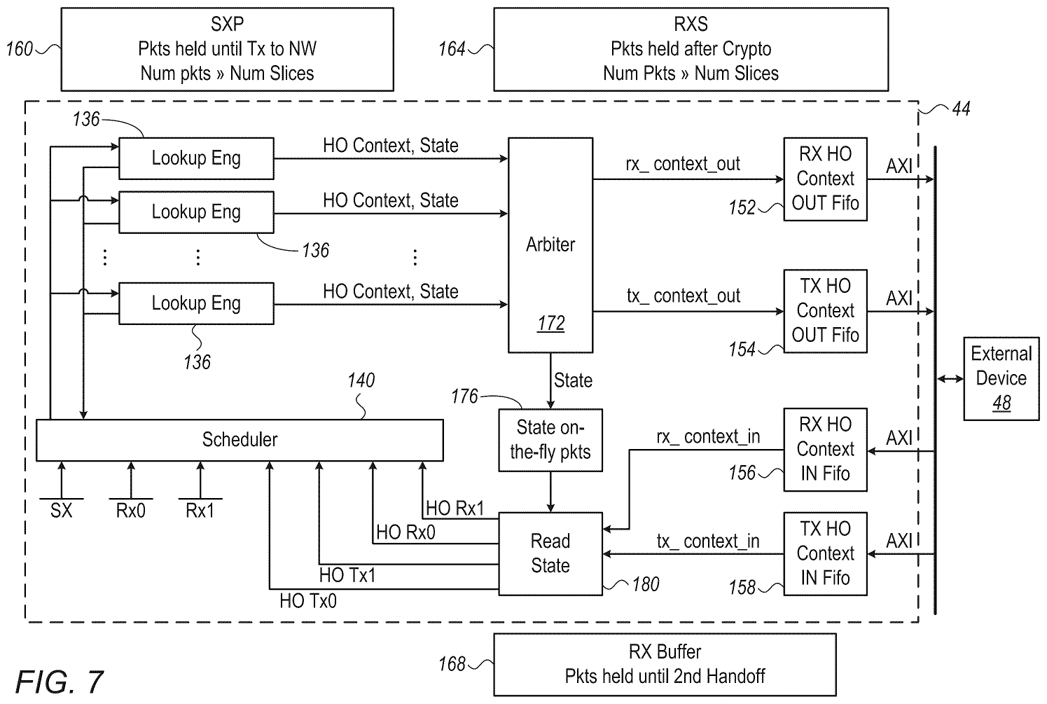

FIG. 7 is a block diagram that schematically illustrates a parallelized pipeline processing and context handoff scheme, in accordance with an alternative embodiment that is described herein. In this example, lookup engines 136 release the slices of the packets that they hand-off to external device 48. In this implementation, any lookup engine 136 can resume processing of any packet that is handed back to the pipeline, regardless of whether it handled the packet before the handoff.

In the embodiment of FIG. 7, to hand-off processing of a packet to external device 48, a given lookup engine output (i) an output context and (ii) a state of the packet. An arbiter 172 sends the output contexts for queuing in FIFOs 152 and 154 as described previously. In addition, arbiter 172 sends the states of the handed-off packets for temporary storage in a state memory 176 (denoted “State on-the-fly pkts” in the figure). Memory 176 stores the states of the packets that have been handed-off to the external device.

When input contexts are received from external device 48, FIFO 156 queues the input contexts of Rx packets, and FIFO 158 queues the input contexts of Tx packets. A state reader 180 accesses memory 176, to read the state corresponding to each input context. The input contexts and the corresponding states are provided to scheduler 140. When scheduling a packet for resumed processing by a given lookup engine 136, scheduler 140 provides the lookup engine with the state of the packet.

The system and network device configurations shown in FIGS. 1 and 4-7 are example configurations that are chosen purely for the sake of conceptual clarity. In alternative embodiments, any other suitable configurations can be used. Elements that are not necessary for understanding the principles of the disclosed solution have been omitted from the figures for clarity.

The various elements of the disclosed systems and network devices may be implemented in hardware, e.g., in one or more Application-Specific Integrated Circuits (ASICs) or FPGAs, in software, or using a combination of hardware and software elements. In some embodiments, certain elements of the disclosed systems and network devices may be implemented, in part or in full, using one or more general-purpose processors, which are programmed in software to carry out the functions described herein. The software may be downloaded to any of the processors in electronic form, over a network, for example, or it may, alternatively or additionally, be provided and/or stored on non-transitory tangible media, such as magnetic, optical, or electronic memory.

It will be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in specification, only the the present definitions in the present specification should be considered.

1. A network device, comprising:
a packet processing pipeline, to apply to a packet a sequence of commands, one of the commands being a handoff command that diverts processing of the packet to an external device; and
handoff circuitry, to:
in response to the handoff command, generate an output context indicative of a current processing state of the packet;
send the output context to the external device;
receive from the external device an input context that (i) reflects the processing applied to the packet by the external device and (ii) specifies subsequent processing of the packet by the packet processing pipeline; and
forward the input context the packet processing pipeline.

2. The network device according to claim 1, wherein the output context comprises (i) a header of the packet and (ii) metadata associated with the packet.

3. The network device according to claim 1, wherein the input context comprises a modified header of the packet, as modified by the external device.

4. The network device according to claim 1, wherein the input context specifies a command to be applied next to the packet by the packet processing pipeline.

5. The network device according to claim 1, wherein:
the packet is encrypted prior to processing by the packet processing pipeline; and
the packet processing pipeline is to divert processing of the packet to the external device at least first and second times, the first time for decrypting the packet and the second time for processing the decrypted packet.

6. The network device according to claim 1, wherein the packet processing pipeline comprises multiple lookup engines to apply the commands to multiple packets in parallel, a given lookup engine to divert processing of a given packet to the external device in response to a lookup result being the handoff command.

7. The network device according to claim 6, wherein the given lookup engine is to retain state information of the given packet, to wait until the given packet has been processed by the external device, and then to resume processing of the given packet using the retained state information.

8. The network device according to claim 6, wherein any of the lookup engines is to receive the input context of the given packet after processing by the external device, to further receive state information of the given packet, and to resume processing of the given packet using the received state information.

9. The network device according to claim 1, wherein the packet processing pipeline and the handoff circuitry are implemented in a first chip, wherein the external device is implemented in a second chip, and wherein the handoff circuitry is to send the output context and receive the input context over a communication bus connecting the first and second chips.

10. A method for packet processing, comprising:
in a packet processing pipeline, applying to a packet a sequence of commands, one of the commands being a handoff command that diverts processing of the packet to an external device; and
in response to the handoff command:
generating an output context indicative of a current processing state of the packet;
sending the output context to the external device;
receiving from the external device an input context that (i) reflects the processing applied to the packet by the external device and (ii) specifies subsequent processing of the packet by the packet processing pipeline; and
forwarding the input context to the packet processing pipeline.

11. The method according to claim 10, wherein the output context comprises (i) a header of the packet and (ii) metadata associated with the packet.

12. The method according to claim 10, wherein the input context comprises a modified header of the packet, as modified by the external device.

13. The method according to claim 10, wherein the input context specifies a command to be applied next to the packet by the packet processing pipeline.

14. The method according to claim 10, wherein:
the packet is encrypted prior to processing by the packet processing pipeline; and
diverting processing of the packet from the packet processing pipeline to the external device at least first and second times, the first time for decrypting the packet and the second time for processing the decrypted packet.

15. The method according to claim 10, wherein applying the commands comprises applying the commands to multiple packets in parallel using multiple lookup engines in the packet processing pipeline, including, in a given lookup engine, diverting processing of a given packet to the external device in response to a lookup result being the handoff command.

16. The method according to claim 15, wherein diverting the processing of the given packet comprises, in given lookup engine:
retaining state information of the given packet;
waiting until the given packet has been processed by the external device; and
resuming processing of the given packet using the retained state information.

17. The method according to claim 15, wherein applying the commands comprises, in any of the lookup engines:
receiving the input context of the given packet after processing by the external device;
further receiving state information of the given packet; and
resuming processing of the given packet using the received state information.

18. The method according to claim 10, wherein the packet processing pipeline and the handoff circuitry are implemented in a first chip, wherein the external device is implemented in a second chip, and wherein sending the output context and receiving the input context are performed over a communication bus connecting the first and second chips.
